(19) United States
(12) Patent Application Publication
(10) Pub. No.: US 2004/0230422 A1
(43) Pub. Date: Nov. 18, 2004

(54) METHOD AND RELATED APPARATUS FOR DETERMINING VOCAL CHANNEL BY OCCURRENCES FREQUENCY OF ZEROS-CROSSING

(76) Inventor: Gin-Der Wu, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,514

(22) Filed: Oct. 5, 2003

(30) Foreign Application Priority Data
May 15, 2003 (TW) 092113210

(51) Int. Cl. G10L 11/06

(52) U.S. Cl. 704/208

(57) ABSTRACT

A method and related apparatus for determined whether a voice signal is mixed with a vocal signal. When applying to a multi-channel system, the method includes: counting number of zero-crossings of a sound signal of each channel within a given period; if the zero-crossing number of the sound signal of a first channel are lower than those of the sound signal of a second channel by a predetermined threshold, determining that the sound signal of the first channel is mixed with a vocal signal.

### BACKGROUND OF INVENTION

1. Field of the Invention

The present invention relates to a method and related apparatus for determined whether a voice signal is mixed with a vocal signal, and more specifically, to a low-cost and low-calculation method and related apparatus for determining vocal signal that counts the number of the zero-crossings in the voice signal.

2. Description of the Prior Art

With the popularity and the progress of the electric and the information technology, the entertainment is variety in modern society. For instance, the system of vocal accompaniment that is called karaoke can be capable of playing the background music of the song. The users can sing with background music to enjoy the professional entertainment environment. With the need of the vocal accompaniment system, the modern entertainment proprietors push the songs that are sang by the professional singers and push the same songs that are only the background music but that are not mixed the vocal signal. The users can use the vocal accompaniment system to play the background music and enjoy singing after listening the songs that are sang by professional singers.

According to the progress of the information storage and the propagation technology, the songs with the vocal signal and the background music are capable of being stored in different channel in a media in the modern electronic technology. Please refer to the FIG. 1. FIG. 1 is a schematic diagram of playing device 10 according to the prior art. The playing device 10 is capable of a video disc player or a video disc driver operating with a computer to read and display the image and the voice data of the song. In the playing device 10, the playing unit 12 is the function of the playing device 10, the playing circuit 12 comprises a receiving circuit 14, a processing module 16, a transferring circuit 18, a interface circuit 20 and a speaker 22. The receiving circuit 14 comprises a motor 24A and a read/write head 24B to read and analyze the signal 25 stored in the video disc 24C that is used as a information storage medium. The processing 16 is used for controlling the playing device 10, and comprises a processing unit 26A and a selection circuit 26B. The processing unit 26A is used for dealing with the signal generated by the receiving circuit 14(ex: modulation, decoding).

From above-mentioned, it is possible to store the song with vocal signal and the song without the vocal signal in different channel in the data processing technology. (ex: video disc 24C). and the processing unit 26A is capable of analyzing the voice signals 27A, 27B in different channels from the signal 25. Additionally, the interface circuit 20 is capable of a control panel to accept users control and transforms the users action to electric signals. The interface circuit 20 transmits the signals that are transformed by the interface circuit 20 to progressing module 16 and the progressing module 16 is capable of controlling the operation of playing device 10 according to the controlling of the user. The selection circuit 26B is capable of accepting the users controlling through the interface circuit 20 to choose one of the voice signals 27A and 27B as a signal 29A and transmits the signal 29 to the transferring circuit 18. The transferring circuit 18 is capable of a digital to analog convertible circuit to convert the digital signal 29A to the analog signal 29B and drives the speaker 22 with the analog signal 29B. The speaker 22 plays the sound wave corresponding to signal 29A and the users can listen it.

In other words, in the playing device 10 of the prior art, the progressing unit 26A is capable of analyzing the signals 27A and 27B stored in different channels in the video disc 24C. Through the users operation choosing the voice signal 27A or 27B to play. Generally, in the current video and sound specification (DVD specification, Digital Versatile Disc), that the different voice signals stored in the right and left channels is specified. It is possible to store the song with vocal signal and the background music without the vocal signal in the video disc 24C respectively. And the user can choose to play the song with vocal signal or the background music without the vocal signal through switching the modes of the playing device 10.

User play voice signals in different channels for different enjoyment. In the current video and sound specification, the vocal signal and the background music are not specified to be stored in the fixed channel.ln some of the music medium sources in the market, the background music is stored in the left channel, and in some of the music medium source in the market, the background music is stored in the right channel. It is unable to agree or decide which is right. User should try to switch the operation modes of the playing device 10 to play the music that they want. For instance, the users want to play the background music without the vocal signal to enjoy the fun of the accompanying, but they cant be sure which channel the background music stored in. So the users can only choose the voice signal in one of the channels to play. When the vocal signal is played, the user should switch the operation modes of the playing device 10 to play the voice in another channel. And the background music is played finally. And it is quite inconvenient for users and the operation process is also minute and complicated.

### SUMMARY OF INVENTION

It is therefore a primary objective of the claimed invention to provide a method and related apparatus for detecting the channel that the vocal signal is stored in.

In the prior art, the background music is stored in right or left channel in the music medium randomly. The playing device of the prior art cant detect the channel that the vocal signal is stored in. Its inconvenient for users to guess and try to find what kind of the voice is stored in left or right channel.

In the claimed invention, the principle that the frequency of the vocal voice is lower than the frequency of the back-ground music is used to calculate and compare the numbers of the zero-crossings of two channels (the level of the voice signal crosses the zero level). When the frequency of the zero-crossings in one of the channels is lower than the frequency of the zero-crossings in another channel, that the voice signal in the channel is mixed with the vocal signal is determined. When the channel that the vocal signal is stored in is detected, the playing device in the claimed invention is capable of playing the voice signal in right channel or left channel according to the users demand for whether the background music is played. And it is not necessary for users to operate the device blindly.

The amount of operations that the method for detecting the channel that the vocal signal is stored in disclosed in the claimed invention is quite less, so that the method for detecting vocal signal can be embodied in simple, quick and inexpensive method or in the software, hardware or firmware. The method disclosed in the claimed invention is not only for detecting the channel that the vocal signal is stored in. But the method can be used for detecting low-frequency signal automatically, quickly and effectively with small amount of operations.

### BRIEF DESCRIPTION OF DRAWINGS

FIG. 1 is a block diagram of the playing device according to the prior art.

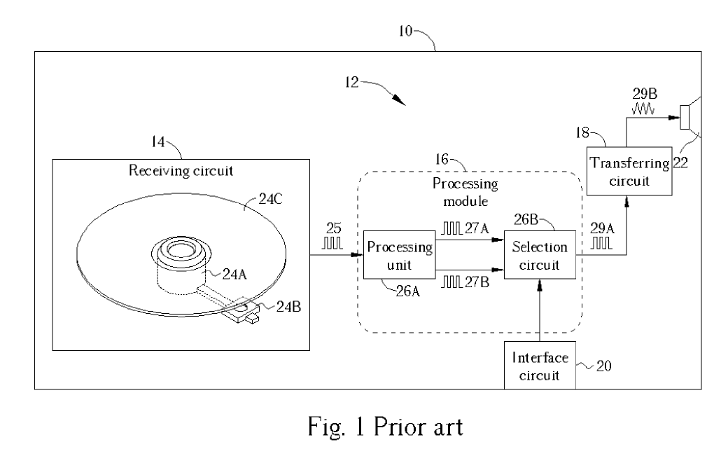

FIG. 2 is a schematic diagram of the typical waveform of every kind of voice signal.

FIG. 3 is a schematic diagram of algorithm determining the channel that the vocal signal is stored in the present invention.

FIG. 4 is block diagram of the playing device for implementing the algorithm of the FIG. 3 in the invention.

FIG. 5 is the table that the zero-crossings numbers of different channels when the invention is implemented.

### DETAILED DESCRIPTION

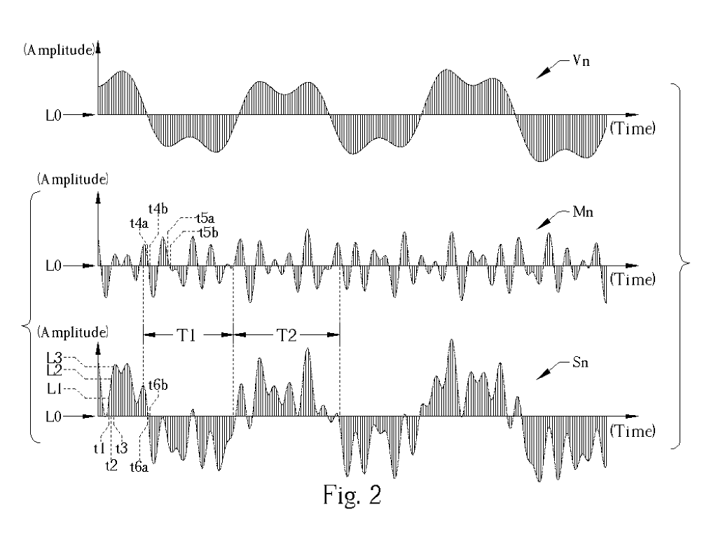

For further explaining the principle of the claimed invention, please refer FIG. 2. FIG. 2 is a schematic diagram of waveforms corresponding to the voice signals. The transverse axle is represented time and the longitudinal axis is represented for amplitude of the waveform. In digital voice signal, the sequence data are represented the amplitudes of the different sample time points in a sound wave. Collecting the data of the voice signals is capable of reconstructing the amplitudes of the sound wave corresponding to the voice signals. For instance, in the FIG. 2, the waveform Sn is formed by the amplitude Li, L2, and L3 recorded in the data corresponding to the sample time points t1, t2 and t3 in a voice signal. In FIG. 2, the waveform Vn is represented the typical waveform of the vocal signals. The waveform Mn is represented the typical waveform of the background music. The waveform Sn is the typical waveform of the voice signal that is mixed with the vocal signal and the background music. It means that the waveform Sn is the result of the waveform Mn mixed with the waveform Vn. The standard level LO marked on the waveform Mn, waveform Vn, waveform Sn is represented zero-level that the amplitude is zero.

Basically, the vocal signal in the song is usually low-frequency. As the waveform Vn shown in the FIG. 2, the waveform is flatter. Oppositely, the music played by the musical instruments is high frequency in the background music. And the opportune time of beginning and the opportune time of ending of every music instrument are not identical. The waveform Mn of the background music usually has a lot of violent vibrations, and the amplitude of the waveform vibrates between the positive part and the negative part frequently. As shown in FIG. 2, the waveform Vn of the low-frequency part in the vocal signal and the waveform Mn of high-frequency part in the background music are mixed to form a song. As shown in FIG. 2, the waveform Sn displays a feature that the high-frequency waveform is carried with the low-frequency waveform. Through observing the waveform Mn that is only the background music and the waveform Sn that is mixed with the vocal signal, although the signal also includes a violent vibrating high-frequency part, but the waveform Sn is mixed with the vocal signal that is lower-frequency so that the amplitude of the waveform wont vibrates between the positive part and the negative part frequently. In the other words, the number that the amplitude of the waveform Sn mixed with the vocal signal crosses the zero-level (zero-crossing) in a predetermined period is less than the number that the amplitude of the waveform Mn only including the background music crosses the zero-level in a predetermined period. For instance, as shown in FIG. 2, in the time frame T1, there are 9 zero-crossings in the vibrated frequently waveform Mn.(between the sample time points t4a and t4b and between the sample time points t5a and t5b) There are 3 zero-crossings in the waveform Sn mixed with the low-frequency vocal signal.(between the sample time point t6a and t6b) Equally, in the time frame T2, the number that the amplitude of the waveform Sn mixed with the low-frequency vocal signal crosses the zero-level in the predetermined period is less than the number that the amplitude of the waveform Mn including the background music crosses the zero-level in the predetermined period. Due to the characteristics of the voice signal that is above-mentioned, comparing and determining whether the voice signal stored in the right channel or in the left channel is mixed with vocal signal according to the number of zero-crossings in the predetermined period (frequency of the zero-crossing).

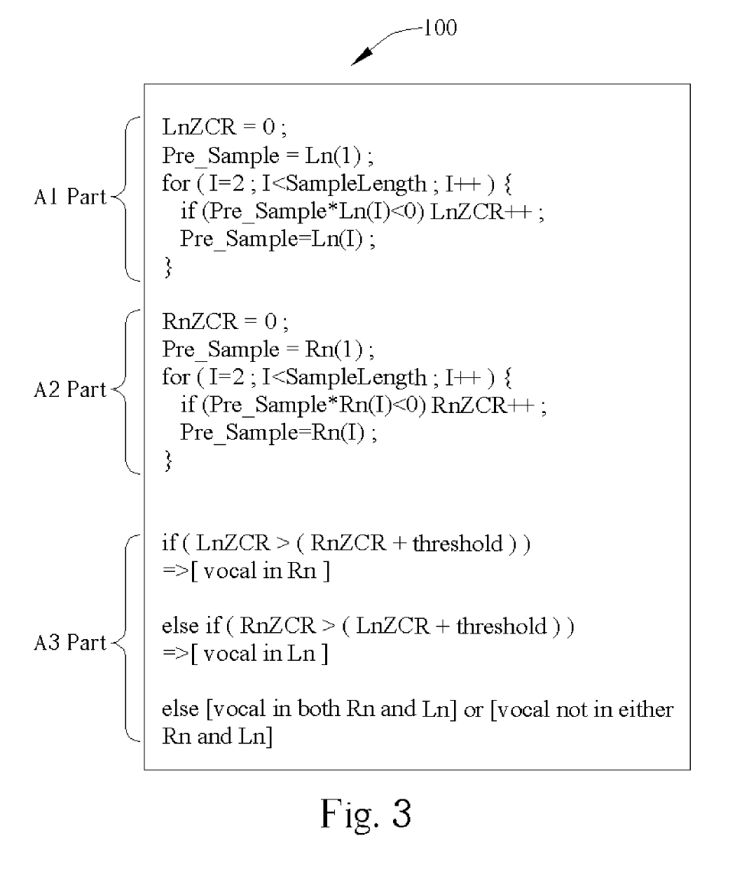

From above-mentioned, that the signal A mixed with low-frequency vocal signal is determined when the zero-crossings numbers of the voice signal in two channels are counted respectively and the zero-crossings number of the signal A is less than the number of the zero-crossings of another signal B. Please refer to FIG. 3. The algorithm 100 in FIG. 3 is performed the programming language algorithm. In algorithm 100, the variables LnZCR and RnZCR are used for recording the result that the number of zero-crossing of voice signal in right and left channels respectively. The variables Ln and Rn are represented the voice signals in right and left channels. From above-mentioned, in the voice signal, the amplitude of the different sample time points recorded in each datum of the voice signal. So the variables Ln and Rn are represented the array variables. The variables with different pointer are represented the data of the voice signal. As shown in FIG. 3, the A1 part of the algorithm is used for counting the zero-crossings numbers of the voice signal Ln. In accordance with the different pointer l, the sign that the neighbor two data Ln(l) times the Ln(l+1) is detected.(amplitude of the neighbor two sample time points in the voice signal) When the sign that the neighbor two data Ln(l) times the Ln(l+1) is negative, there is a zero-crossing between the neighbor two sample time points corresponding to the neighbor two data in the voice signal corresponding to the variable Ln. And the variable LnZCR is capable of adding 1. It means that the zero-crossings number of the voice signal corresponding to the variable Ln is added 1. When the A1 part is implemented, the upper bound is capable of being set by a variable SampleLength. In the other words, the variable SampleLength is corresponding to a predetermined period. The A1 part of the algorithm 100 is used for counting the zero-crossings numbers of the voice signal corresponding to the variable Ln in the predetermined period and storing the counting result of the zero-crossings numbers in the variable LnZCR. Equally, the A2 part of the algorithm 100 is used for counting the zero-crossings numbers of the voice signal corresponding to the variable Rn (the voice signal in the other channel) in the predetermined period(The predetermined period is controlled by the variable SampleLength), and storing the counting result of the zero-crossings in the variable RnZCR. When the sign that the neighbor two data Ln(l) times the Ln(l+1) is positive, there is not a zero-crossing between the neighbor two sample time points corresponding to the neighbor two data in the voice signal corresponding to the variable Ln.

The A3 part of the algorithm 100 in the invention is used for comparing the zero-crossings numbers of the two voice signals to determine the channel that the voice signals with low-frequency vocal signal is stored in. As algorithm 100 in FIG. 3 shown, when the variable Ln corresponding to the zero-crossing numbers LnZCR of the voice signal is much larger than the zero-crossing numbers RnZCR of another voice signal (the difference of the two variables is larger than a predetermined threshold value), whether the voice signal corresponding to the variable Rn is mixed with the low-frequency vocal signal that can be determined. Oppositely, the zero-crossing numbers LnZCR of the voice signal corresponding to the variable Ln in the predetermined period is less than the zero-crossing RnZCR numbers of the another voice signal corresponding to the variable Ln in the predetermined period. (the difference of the two variables LnZCR, RnZCR is larger than a threshold), whether the voice signal corresponding to the variable Ln is mixed with the vocal signal that can be determined. If the relation of the two variables LnZCR, RnZCR is not tally with two relations that are above-mentioned (the difference of the two variables LnZCR, RnZCR is less than the threshold), it is possible that the voice signals in left and right channels are mixed with vocal signal or that the voice signals in left and right channels are mixed without vocal signal. In these cases, some other steps are used in the invention. For instance, when the voice signals are mixed with vocal signals, the reducing step can be used when the voice signal is operated through a special filtering process or other signal process to reduce and filter the low-frequency vocal signal in the voice signal. For instance, the band-stop filter is used for filtering the signal in the vocal bandwidth in the voice signal.

In the other words, the algorithm 100 in FIG. 3 is used for comparing the zero-crossings numbers of the voice signals in different channels to determine the channel that the voice signal is mixed with the vocal signal is stored in. Please pay attention to the amounts of operations in the algorithm 100 of the invention is quite less. It is only for counting the numbers of the zero-crossings to determine whether the zero-crossings appears, and compares the positive value and the negative value of the neighbor two data of the voice signal. In fact, one bit in the data that is represented amplitude is represented the positive amplitude or negative amplitude (it is the sign bit). Determining whether the zero-crossing appears in the neighbor two data. It only operates the neighbor two data in exclusion operation (or exclusive OR). When the sign bits of the neighbor two data are not the same, there is a zero-crossing between the neighbor two data. Determining the zero-crossing in the method that the sign bits operates in exclusion operation so that the amounts of operations in the algorithm 100 of the invention is smaller and the algorithm 100 in the invention can operates more quickly.

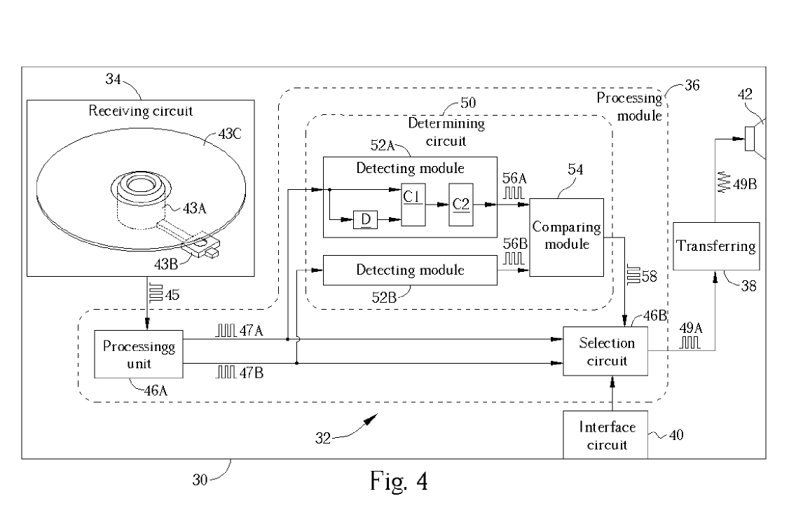

Please refer to FIG. 4. FIG. 4 is a block diagram of the palying device 30 according to the present invention. The function of playing device 30 is operated by the palying circuit 32. The palying circuit 32 includes a receiving circuit 34, a processing module 36, a interface circuit 40, a transferring circuit 38 and a speaker 42. The playing device 30 is capable of a video player or a video driver, and includes a motor 43A and a laser read/write head 43B. And reading the signal 45 (like the video signals) from a video disc 43C. The processing module 36 includes a processing unit 46A, a determining circuit 50 and a selection circuit 46B. The interface circuit 40 is capable of a control panel to accept the users controlling. The processing module controls the playing device 30 according to the users controlling accepted by the interface circuit 40. The processing unit 46A in the processing module 36 can operate the further signal processing (like the decoding, modulation or demodulation). The signals 47A and 47B that are in left and right channels are analyzed from the signal 45. And then one of the signals 47A and 47B is chosen as the signal 49A through the controlling of the selection circuit 46B. The transferring circuit 38 can transform the digital signal 49A to the analog signal 49B and transmits the signal 49B to the speaker 42 to transform into the sound wave and to play.

In the playing device 30 of the invention, the selection circuit 46B is the same as the playing device 10. The selection circuit 46B can play the voice signal in one of the channels that is chosen by user according to the users controlling through interface circuit 40. The selection circuit 46B also can realize the algorithm of the present invention in the FIG. 3 and detect the voice signal mixed with the vocal signal between the voice signals 47A and 47B stored in the right and left channels automatically and controls the selection circuit 40 to choose the suitable voice signal as the signal 49A. In the other word, in the users operation interface of the playing device 30 in the invention, except playing the voice signals between right and left channels manually, there is a “karaoke mode”(Without vocal mode) in the users operation interface. In the karaoke mode, the selection circuit 50 in the invention operates. The selection circuit 50 detects the voice signal that is not mixed with vocal signal between voice signal 47A and 47B automatically and play the signal 49 through the transferring circuit 38 and speaker 42. And the users can find the background music between right and left channels without the minute and complicated processes. Equally, there is a “song mode” in the playing device 30. When the playing device 30 operates in the song mode, the determining circuit 50 can detect the song voice signal mixed with the vocal signal in the voice signal 47A and 47B to play.

For realizing the algorithm 100 of the invention in FIG. 3, the determining circuit 50 can realize two detecting module 52A, 52B and a comparing module 54. The detecting modules 52A and 52B can count the zero-crossing numbers of the voice signals in the right and left channels respectively and output the results of the zero-crossings 56A and 56B. The detecting modules 52A and 52b are used for realizing the Al part and A2 part in the algorithm 100 in the FIG. 3. The comparing module 54 is capable of realizing the A3 part of the algorithm 100 in the invention in the FIG. 3. According to the relation of the zero-crossings numbers of the voice signals 47A and 47b in a predetermined period, the comparing module 54 determines which voice signal is the background music that is not mixed with the vocal signal, and outputs a corresponding comparing result 58.According to the comparing result 58, the selection circuit 46B is capable of choosing a suitable voice signal from the voice signals 47A and 47B as the signal 49A and transmits the signal 49A to the transferring circuit 38. The embodiments of the detecting module 52A and 52B are the same. For instance, the detecting module 52A is capable of realizing a delayer D. and the comparing unit C1 compares the neighbor two data in the voice signal 47A whether one the data is positive and the other one is negative. From above-mentioned, the comparing unit C1 is capable of an exclusive gate or other logical operator to compare whether the sign bits of the neighbor two data in the voice signal 47A are the same. When one sign bit of the neighbor two data are positive and the other one is negative, the zero-crossings appears. And the comparing unit C1 triggers a counting unit C2 to increase the zero-crossings number 1. When the two sign bits of the neighbor two data in the voice signal 47A are the same sign, (the two sign bits are the positive sign or negative sign) the comparing unit C1 doesnt trigger the counting unit C2 to increase the zero-crossings number 1. After a determined period time (defined by the variable SampleLength in FIG. 3), the comparing unit C1 transmits the counting result of the zero-crossings 56A to the comparing module 54. In the invention, the function of determining module 50 is capable of being realized by the simple logical circuit or way of firmware. In the other words, in the algorithm 100 in the FIG. 3 is capable of being compiled as a programming code. And the programming code is capable of being stored in the processing module 36 or related nonvolatile memory (for example: flash memory, it is not present in FIG. 4.). The processing module 36 implements the function of the programming code, and it means that the processing implements the function of the determining circuit 50. The processing module 36 is capable of determining which voice signal 47A or 47B is mixed with the vocal signal.

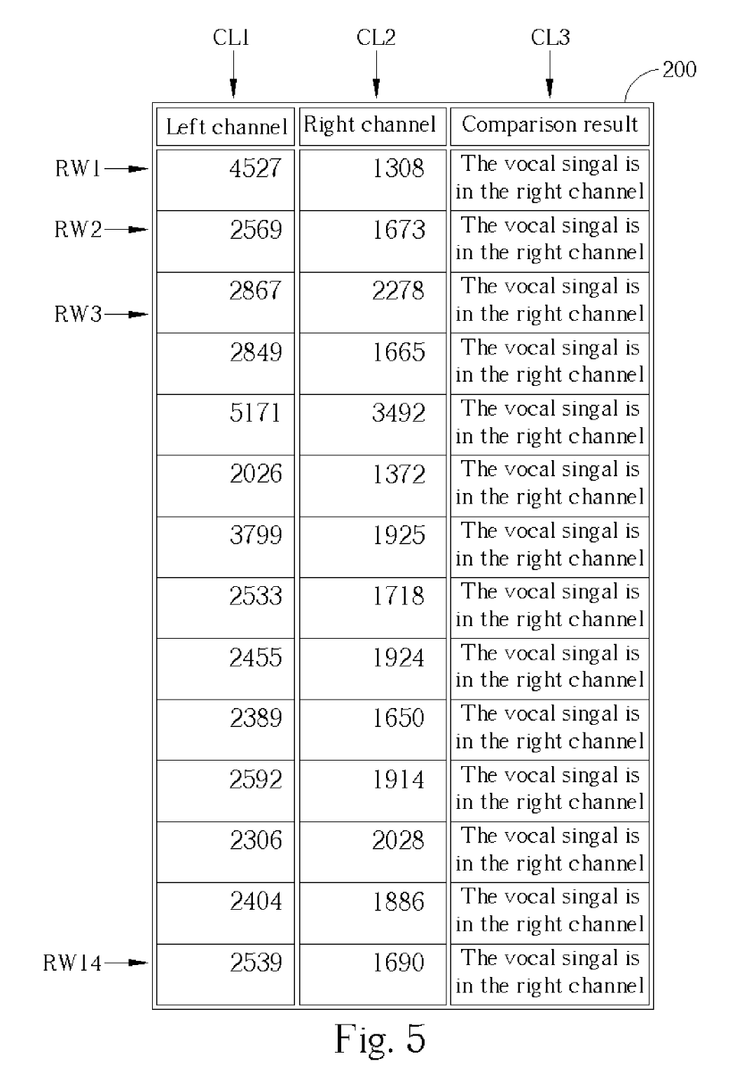

Please refer to the FIG. 5 (and refer to the FIG. 3). The table 200 is the result of the zero-crossings numbers that the algorithm 100 in the invention (Please refer to the FIG. 3) is implemented with the voice signals that are in the right and left channels of the typical music medium. The zero-crossings numbers of the right and left channels are recorded in the column CL1 and CL2 in the table 200. The determining result of A3 part in the algorithm 100 is recorded in the column CL3. And each row is represented the zero-crossings number of the two channels in the different time frame. The sample rate of voice signal in the two channels is 44100 HZ. It means that there are 44100 data per second in the voice signal. The predetermined period that the zero-crossings numbers is counted is 1 second. (It means that the initial value of variable SampleLength in the algorithm 100 is 44100, because there are 44100 data per second) The threshold value in the algorithm 100 is set to 200 when the comparing result is out-putted. (The algorithm 100 is implemented one time per a determined period time.) For instance, the row RW1 is represented that there are 4527 zero-crossings in the left channel and there are 1308 zero-crossings in the right channel between the Nth second and the (N+1)th second (or from the Nth second to (N+1)th second). After implementing the A3 part in the algorithm 100, the voice signal in the left channel is not mixed with the vocal signal. (Because the zero-crossings numbers of the left channel is larger than the zero-crossings numbers of the right channel, and the difference of the zero-crossings number of the two channels is larger than the threshold.) And between the (N+1)th second and the (N+2)th second, the algorithm 100 is implemented once more. The zero-crossing number is counted once more, and the counting result is as shown in the row RW2 that there are 2569 zero-crossings in the left channel and there are 1673 zero-crossings in the right channel. The voice signal in the right channel mixed with the vocal signal is capable of being determined. The row RW3 is represented the zero-crossings numbers that is counted and the comparing result between the (N+2)th second and the (N+3)th second. Finally, the row RW14 is represented the zero-crossings numbers and comparing result of the two channels between the (N+13)th second and the (N+14)second. After listening the voice signals of the right and the left channels, the voice signal in the right channel is really mixed with the vocal signal. The voice signal in the left channel is the background music without vocal signal. In conclusion, as known from the FIG. 5, the voice signal stored in right or left channel that is mixed with the voice signal is determined according to the algorithm 100 disclosed in the FIG. 3.

From above-mentioned, the “song mode” and the “karaoke mode” are capable of being set in the playing device 30(please see the FIG. 4). The determining circuit 50 realizes the algorithm 100 to determine the channel that the vocal signal is stored in automatically. In the operation process, the determining circuit 50 counts the zero-crossings number of each voice signal once more per a predetermined period according to the FIG. 5. And the determining device 50 compares and determines that of two channels. The determining device 50 chooses the suitable channel according to the comparing result in each predetermined period. Additionally, the threshold value of the algorithm 100 is used for avoiding the error-determining. Because the zero-crossings number in each channel is a random value, in some predetermined period or in some special condition, it is possible that the zero-crossings number in the channel that the voice signal mixed with the vocal signal is stored in is larger than the zero-crossings number in the channel that the voice signal without the vocal signal is stored in. But the difference of the zero-crossings numbers of the two channels is not a quite large value so that the threshold value used in the algorithm 100 is capable of avoiding the error-determining. When the difference of the zero-crossing number of the two channels is larger than the threshold value, the method that determining the channel that the vocal signal is stored in according to the zero-crossings number is meaningful. When the difference of the zero-crossing number of the two channels is less than the threshold value, the difference of the zero-crossings maybe resulted from the some random occurrence zero-crossings. It is not very meaningful. But the special case is hard to occur according to the FIG. 5.

Besides the principle of the present invention is used in video player and video driver, the principle of the present invention is capable of being used in other displaying devices. And the principle of the present invention is also capable of being used in one part of the player software in the computer. For instance, the receiving circuit 34 is capable of the servo-structure in the FIG. 4. And the receiving circuit 34 is also capable of a wired or wireless network interface circuit and is capable of receiving the video and sound signal from the wired or wireless network. The processing module 36 is capable realizing a restrained filtering module (it doesnt occur in the FIG. 4). When the difference of the zero-crossings of the two voice signal 47A and 47B is not larger than the threshold value, the restrained filtering module can filter the vocal signal. Additionally, some special form video data (like the music data that is the mp3 form).should be decoded and is played by a special player software. The algorithm in the invention is capable of implementing in this kind of player software to determine the channel that the vocal is stored in. Additionally, known from the principle discussing in the FIG. 2, the invention is capable of being used for determining the channel that the vocal signal is stored in and is also capable of being used in multi-channels system to find the channel that the low-frequency signal is stored in with the method that is low-calculation, low cast and quick and efficient.

The playing device of the prior art cant determine the channel that the vocal signal is stored in of the multi-channels system in a efficient and low-calculation method so that the users should switch the channel to find the voice signal mixed with the vocal signal. The present invention discloses a method and related apparatus to count the zero-crossings number of each channel in the determined period time and determine the channel that the vocal signal is stored in according to the difference of the zero-crossings numbers. The playing device is capable of determining the channel that the vocal signal is stored in automatically. It means that the users can enjoy the more convenient video and sound playing service and ignore the trouble that the users try themselves.

Those skilled in the art will readily observe that numerous modifications and alterations of the device may be made while retaining the teachings of the invention. Accordingly, the above disclosure should be constructed as limited only by the metes and bounds of the appended claims.

1. A method for determining whether a first voice signal is mixed with a low-frequency voice signal; the first voice signal comprising: a plurality of signal data, each datum representing the amplitude of the first voice signal at a different time; the method comprising:
setting a standard level and a predetermined period of time;
counting the number of times that the amplitude of the first voice signal crosses the standard level in the predetermined period, and outputting a corresponding counting result; and
determining whether the voice signal is mixed with the low-frequency voice signal by comparing the counting result with a threshold value.

2. The method of claim 1 wherein determining that the first voice signal is mixed with the low-frequency voice signal according to the counting result when the counting result is smaller than the threshold value.

3. The method of claim 1 wherein determining that the first voice signal is not mixed with the low-frequency voice signal according to the counting result when the counting result is larger than the threshold value.

4. The method of claim 1 wherein the bandwidth of the low-frequency voice signal is equal to the bandwidth of the first voice signal.

5. The method of claim 1 wherein the counting step comprises comparing whether one of a current datum and a next datum is larger or smaller than the standard level in the predetermined period, wherein a zero-crossing between the current datum and the next datum in the first voice signal is determined when one of the current datum and the next datum is larger than the standard level and other is smaller than the standard level.

6. The method of claim 1 wherein the standard level is a zero level.

7. The method of claim 1 further comprising reducing the amplitude of the low-frequency voice signal in the first voice signal when the first voice signal is determined to be mixed with the low-frequency voice signal.

8. The method of claim 1 further comprising:
providing a second voice signal comprising a plurality of data, each datum representing the amplitude of the second voice signal at a different time;
counting the number that the amplitude of the second voice signal crosses the standard level in the predetermined period, and outputting a corresponding second counting result; and
determining whether the second voice signal is mixed with the low-frequency voice signal according to whether the counting result of the first voice signal is larger than the second counting result.

9. The method of claim 8 wherein determining whether the second voice signal is mixed with the low-frequency voice signal is performed when the counting result is smaller than the threshold value and the first voice signal is determined to be mixed with the low-frequency voice signal.

10. A playing circuit comprising:
a determining circuit for determining whether a first voice signal is mixed with a low-frequency voice signal, the first voice signal comprising a plurality of signal data, each datum representing the amplitude of the first voice signal at a different time, the determining circuit comprising:
a detecting module for counting zero-crossings in a predetermined period and outputting a corresponding counting result; and
a comparing module for determining whether the first voice signal is mixed with the low-frequency voice signal by comparing the counting result with a threshold value.

11. The playing circuit of claim 1 wherein when the counting result is smaller than the threshold value, the comparing module determines that the first voice signal is mixed with the low-frequency signal.

12. The playing circuit of claim 1 wherein when the counting result is larger than the threshold value, the comparing module determines that the first voice signal is not mixed with the low frequency signal.

13. The playing circuit of claim 10 wherein the bandwidth of the low-frequency voice signal is equal to the bandwidth of the first voice signal.

14. The playing circuit of claim 1 wherein the detecting module compares a current datum and a next datum with a standard level, wherein when one of the current datum and the next datum is larger than the standard level and the other of the current datum and the next datum is smaller than the standard level, the detecting module determines that there is a zero-crossing between the current datum and the next datum in the first voice signal.

15. The playing circuit of claim 14 wherein the standard level is a zero level.

16. The playing circuit of claim 10 further receiving a second voice signal comprising a plurality of data, each datum representing the amplitude of the second voice signal at a different time, and the determining circuit further comprising:
a second detecting module for counting a number of times that the amplitude of the second voice signal crosses a standard level in the predetermined period, and outputting a corresponding second counting result;
wherein the comparing module determines that the first voice signal is mixed with the low-frequency signal when the counting result of the first voice signal is larger than the second counting result.

17. The playing circuit of claim 16 wherein the determining module determines that the first voice signal is mixed with the low-frequency signal when the counting result is smaller than the second counting result.

18. The playing circuit of claim 16 further comprising a speaker for comparing the result determined by the comparing module and transforming the second voice signal into sound.

19. The playing circuit of claim 10 further comprising a receiving circuit to generate the first voice signal.

20. The playing circuit of claim 19 wherein the receiving circuit is capable of reading the first voice signal from a video disc.
